(19) United States
(12) Patent Application Publication
(10) Pub. No.: US 2009/0046758 A1
(43) Pub. Date: Feb. 19, 2009

(54) Induction Thermography Test Stand

(76) Inventors: Joachim Baumann, Munchen (DE); Matthias Goldammer, Munchen (DE); Max Rothenfusser, Munchen (DE); Johannes Vrana, Orlando, FL (US)

Correspondence Address: BAKER BOTTS L.L.P.;PATENT DEPARTMENT, 98 SAN JACINTO BLVD., SUITE 1500, AUSTIN, TX, 78701-4039, US

(21) Appl. No.: 12/168,320

(22) Filed: Jul. 7, 2008

(30) Foreign Application Priority Data
Jul. 10, 2007 (DE) 10 2007 032 063.0

(51) Int. Cl. G01N 25/72

(52) U.S. Cl. 374/5; 374/E13.001

(57) ABSTRACT

The induction thermography test stand has at least two inductors arranged angled relative to one another, at least in sections, and at least one alternating current source for powering the inductors with alternating currents which differ in terms of their frequency and/or phase such that a current with a temporally changing direction can be induced in a test module. With a method for determining flaws in test modules using induction thermography, a current with a temporally changing direction is induced in the test module.

### CROSS-REFERENCE TO RELATED APPLICATIONS

This application claims priority to German Patent Application Number 10 2007 032 063.0 filed on Jul. 10, 2007, and which is incorporated herein by reference in its entirety.

### TECHNICAL FIELD

The invention relates to an induction thermography test stand and a method for determining flaws in test modules by means of induction thermography.

### BACKGROUND

Induction thermography is a method for analyzing materials in a non-destructive fashion. Here a current is induced in an electrically conductive test object in the opposite direction by means of an alternating current flowing in the coil (inductor). If a component contains a crack, the current flowing through the test object has to flow around the crack. The increased current density at the crack ends causes the test object at the crack ends to be heated more intensively; this can be detected using an infrared camera. The crack is however only heated if the crack also represents the largest possible resistance for the current. It offers the largest and smallest possible resistance here if it is oriented precisely at right angles or precisely in parallel to the current direction in each instance. As a result, cracks are all the more difficult to detect, the more their orientation deviates from the perpendicular relative to the current flow, and cracks which are oriented precisely in parallel to the current can no longer be detected.

To be able to detect cracks in all directions with a high degree of probability, two measurements were previously implemented, in which the alignment of the inductor relative to the component is typically rotated about 90°.

### SUMMARY

A possibility for simply and reliably testing the material for flaws on the basis of induction thermography can be provided according to an embodiment by an induction thermography test stand comprising at least two inductors arranged angled at least in sections relative to each other, and at least one alternating current source for powering the inductors with alternating currents which differ in terms of their frequency or their phase such that a current with a temporally changing direction can be induced in a test module.

According to further embodiment, at least two of the inductors may be at least in sections angled relative to each other at an angle of essentially 90°. According to further embodiment, the induction thermography test stand may be set up such that in the case of the same frequency of the alternating currents, the phase difference of at least two of the alternating currents for powering the respective inductors amounts to 90° or 270°. According to further embodiment, the induction thermography test stand may be set up such that the frequency difference of at least two of the alternating currents for powering the respective inductors is not equal to zero and not equal to a whole-number multiple.

According to another embodiment, a method for determining flaws in test modules by means of induction thermography, the method may comprise the step of inducing a current with a temporally changing direction into the test module.

According to further embodiment, the current with a temporally changing direction in the test module may be generated by means of allowing respective currents to flow through at least two inductors arranged at least in sections angled relative to each other, and having a frequency and phrasings which differ relative to each other. According to further embodiment, the current with a temporally changing direction in the test module can be generated by allowing respective currents to flow through two inductors arranged at least in sections angled relative to each other by essentially 90°, and having a frequency and/or phasing which differ from each other. According to further embodiment, in the case of the same frequency of the alternating currents of the phase difference, at least two of the alternating currents for powering the respective inductors may amount to 90° or 270°. According to further embodiment, the frequency difference of at least two of the alternating currents for powering the respective inductors may be not equal to zero and not equal to a whole-number multiple.

### BRIEF DESCRIPTION OF THE DRAWINGS

The invention is described schematically in a more precise fashion with reference to an exemplary embodiment.

FIG. 1 shows a front view of a section from a conventional induction thermography test stand with a test module having a transverse crack;

FIG. 2 shows a front view of a section from the conventional induction thermography test stand in FIG. 1 with a test module having a longitudinal crack;

FIG. 3 shows a sectional representation of a side view of a section from an induction thermography test stand with a test module having a transverse crack;

FIG. 4 shows a front view of a section from an induction thermography test stand according to an embodiment similar to FIG. 1 having a test module with a transverse crack;

FIG. 5 shows a front view of a section from the induction thermography test stand in FIG. 3 according to an embodiment having a test module with a longitudinal crack.

### DETAILED DESCRIPTION

The induction thermography test stand has at least two inductors which are arranged at angles relative to each other, at least in sections, e.g. crossed, as well as at least one alternating current source for powering these inductors with alternating currents which differ in terms of their frequency and/or their phase, such that a current with a temporally changing direction can be induced in a test module.

This means that the currents are to either have a different frequency in at least two of the inductors which are angled relative to each other or an offset phase or combination thereof in the case of the same frequency. With the same frequency and a phase offset of 0° and/or 180°, only a rotated current vector is however obtained in a temporally non-variable direction, which corresponds to the means of the two inductor alignments, which is to be avoided at least with only two inductors.

Naturally, more than two inductors can also be present.

In the method for determining the flaws in test modules using induction thermography, a current with a temporally changing direction is induced into the test module.

It is advantageous if the test stand is set up such that at least two of the inductors are angled relative to each other at an angle of essentially 90°, at least in sections, since an equal current direction change can be easily introduced into the test module.

It is also advantageous if the test stand is set up such that the phase difference of the alternating currents for powering the respective inductors amounts to 90° or 270°, in order to induce equally sized currents in the case of two inductors irrespective of the angle. With a phasing offset by 90° and/or 270° and with two inductors rotated about 90°, the current direction rotates without changing the intensity of the induced current with the excitation frequency about the point of intersection of the inductors and cracks can subsequently be detected in all directions. With the same frequency and a phase offset which is not equal to 90° or 270°, but is not 0° or 180° or with inductors which are not rotated to one another by 90°, the current still rotates with the excitation frequency, the current intensity only depends on the direction, so that a lower current intensity is induced for some angle ranges. As a result, the effect that cracks can be detected in all directions is somewhat restricted. Similarly, the intensity of the induced current depends on the direction in the case of not equal alternating currents for powering the inductors.

In the case of more than two inductors, which have a common point of intersection, the phase shifts and current intensities of the supply alternating currents are preferably adjusted to those angles in order for the inductors to be rotated relative to one another. By way of example, a current which rotates without changing the current intensity with the excitation frequency is induced in the test module, with a phase shift by 120° respectively in the case of three inductors with a common point of intersection, which is rotated relative to one another by 60° in each instance. With more than two inductors which do not have a common point of intersection an induced current cannot be achieved in the test module, which rotates without a change in current intensity, instead, the most effective distribution of the induced current possible in all directions is enabled by way of optimizing the angle.

It may alternatively or additionally be advantageous if the frequency difference of at least two of the alternating currents for powering the respective inductors is not equal to zero and not equal to a whole-number multiple. In the case of different frequencies, the current vector rotates with the differential frequency (beat frequency). An effective detection of cracks irrespective of their orientation is also possible with this variant. Here it should be noted that with whole-number multiples of the frequencies (in particular double and/or half), only a restricted angular range is covered and that in the case of very marginally different frequencies, the current vector rotates slowly. In this instance, the measurement time is to be of such duration that the current vector can also cover all regions of the current directions and cracks in all directions result in a local heating of the component which is sufficient for detection purposes.

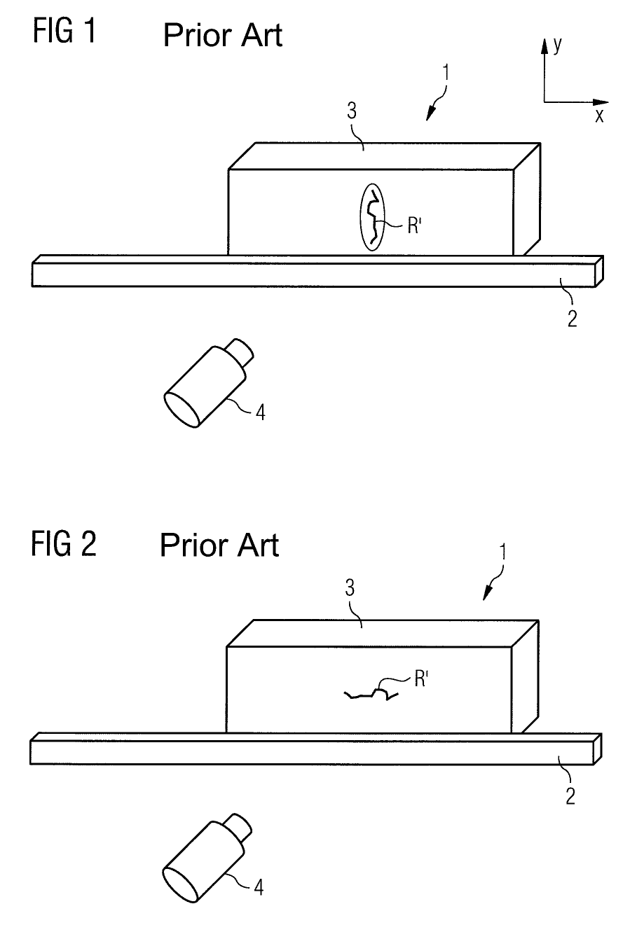

FIG. 1 shows an induction thermography test stand 1 with a section of a current flowing through an inductor 2, which is parallel to the x-axis. The inductor 2, e.g. an induction loop, is arranged in parallel in this example and at a distance from a cuboid test module 3, the longitudinal axis of which is likewise aligned in parallel to the x-axis. The test module 3 has a transverse crack R, i.e. a crack, the crack edge(s) of which lie(s) essentially at right angles to the x-axis. A current can be induced through the inductor 2 in the test module 3 in a known manner, as a result of which the test module 3 heats up. The temperature of the test module 3 is scanned by means of a thermal imaging camera 4.

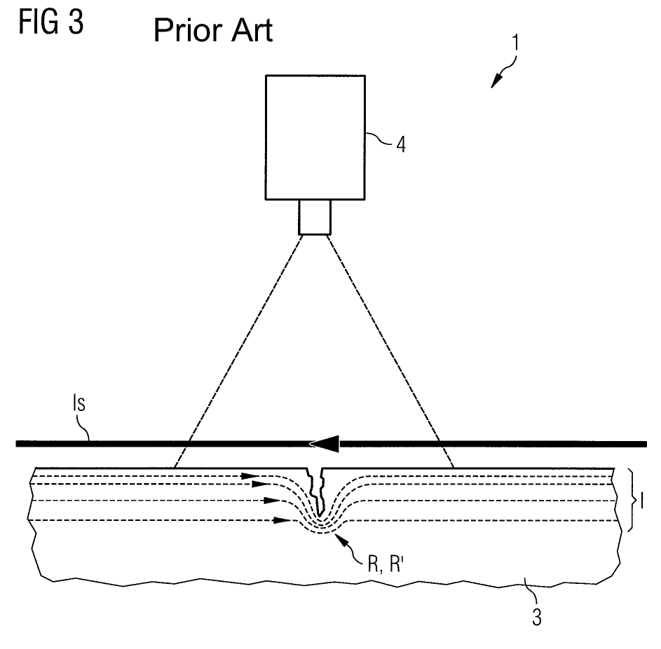

Depending on the orientation of the crack R relative to the flow direction, the current intensity and thus also the temperature can increase considerably locally around the crack R, as is detailed more precisely in FIG. 3. In the example shown, a transverse crack R produces the highest current density and thus a significant local increase in temperature. The temperature increase can indicate the presence of the crack R (or another flaw).

FIG. 2 shows the same arrangement, however with a longitudinal crack R′, i.e. a crack, the crack edge(s) of which is/are essentially parallel to the x-axis. Such a crack R′ only achieves a minimal resistance for the induced current and thus only results in a marginal temperature increase, if applicable a temperature increase which cannot be detected or can only detected with difficulty. At least two measurements were previously implemented, in which the alignment of the inductor 3 is typically rotated about 90° to another, thereby inducing a significant measuring effort.

FIG. 3 shows a cross-section from the test module 3, which has a surface transverse crack R. A current I in the test module 3 is induced through a current Is flowing in the inductor. This current I, the current lines of which are illustrated with dashes, is intensified at the crack tips, so that the material of the test module 3 is heated more significantly as a result of the higher current density locally present there. This relative increase in temperature is detected by the thermal imaging camera 4.

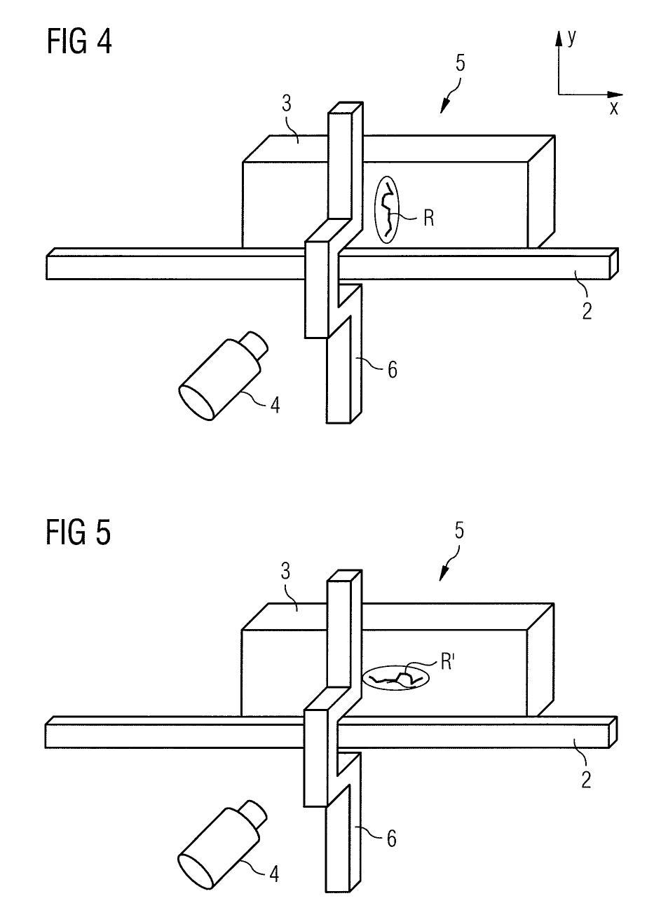

FIG. 4 shows an induction thermography test stand 5 like FIG. 1 according to various embodiments, and in addition an inductor section 6 of another inductor rotated (“crossed”) by 90° relative to the first inductor section. The two inductor sections 2, 6 (different inductors) are controlled here with phasings which differ relative to each other by 90° and/or 270°. As a result, the current direction in the test module changes continuously with the excitation frequency, so that a crack orientation is determined optimally. The transverse crack R from FIG. 4 is thus essentially detected in a similarly effective way as the longitudinal crack R′ in FIG. 5.

In an alternative embodiment, more than two inductors can also cross. Inductors can also cross at more than two points.

In an alternative embodiment, activation is possible with the same frequency and a phase offset which is less than or greater than 90°. With a phase offset of less than 90°, some angular ranges are however not covered by the current vector.

As a result, the effect that cracks can be detected in all directions is somewhat restricted.

In an alternative embodiment, the frequency difference of the alternating currents in the inductors for powering the respective inductors is not equal to zero. With different frequencies, the current vector rotates with the differential frequency (beat frequency). Also with this variant, an effective detection of cracks is also possible irrespective of the orientation thereof, except with whole-number multiples of the frequencies (in particular double and/or half), in which only a restricted angular range is covered. Combinations of frequency differences and phase differences can also be set.

What is claimed is:

1. An induction thermography test stand comprising at least two inductors arranged angled at least in sections relative to each other, and at least one alternating current source for powering the inductors with alternating currents which differ in terms of their frequency or their phase such that a current with a temporally changing direction can be induced in a test module.

2. The induction thermography test stand according to claim 1, wherein at least two of the inductors are at least in sections angled relative to each other at an angle of essentially 90°.

3. The induction thermography test stand according to claim 2, which is set up such that in the case of the same frequency of the alternating currents, the phase difference of at least two of the alternating currents for powering the respective inductors amounts to 90° or 270°.

4. The induction thermography test stand according to claim 1, which is set up such that the frequency difference of at least two of the alternating currents for powering the respective inductors is not equal to zero and not equal to a whole-number multiple.

5. A method for determining flaws in test modules by means of induction thermography, the method comprising the step of inducing a current with a temporally changing direction into the test module.

6. A method according to claim 5, wherein the current with a temporally changing direction in the test module is generated by means of allowing respective currents to flow through at least two inductors arranged at least in sections angled relative to each other, and having a frequency and phrasings which differ relative to each other.

7. The method according to claim 6, wherein the current with a temporally changing direction in the test module is generated by allowing respective currents to flow through two inductors arranged at least in sections angled relative to each other by essentially 90°, and having a frequency and/or phasing which differ from each other.

8. The method according to claim 7, wherein in the case of the same frequency of the alternating currents of the phase difference, at least two of the alternating currents for powering the respective inductors amounts to 90° or 270°.

9. The method according to claim 6, wherein the frequency difference of at least two of the alternating currents for powering the respective inductors is not equal to zero and not equal to a whole-number multiple.

10. An induction thermography test stand comprising at least two inductors arranged angled at least in sections relative to each other, and at least one alternating current source for powering the inductors with alternating currents which differ in terms of their frequency and their phase such that a current with a temporally changing direction can be induced in a test module.

11. The induction thermography test stand according to claim 10, wherein at least two of the inductors are at least in sections angled relative to each other at an angle of essentially 90°.

12. The induction thermography test stand according to claim 11, which is set up such that in the case of the same frequency of the alternating currents, the phase difference of at least two of the alternating currents for powering the respective inductors amounts to 90° or 270°.

13. The induction thermography test stand according to claim 10, which is set up such that the frequency difference of at least two of the alternating currents for powering the respective inductors is not equal to zero and not equal to a whole-number multiple.
